(19) United States
(12) Patent Application Publication
(10) Pub. No.: US 2022/0222359 A1
(43) Pub. Date: Jul. 14, 2022

(54) FAULT TOLERANT TELEMETRY OF DISTRIBUTED DEVICES

(71) Applicants: Kshitij Arun Doshi, Tempe, AZ (US); Francesc Guim Bernart, Barcelona (ES); Ned M. Smith, Beaverton, OR (US)

(72) Inventors: Kshitij Arun Doshi, Tempe, AZ (US); Francesc Guim Bernart, Barcelona (ES); Ned M. Smith, Beaverton, OR (US)

(21) Appl. No.: 17/711,542

(22) Filed: Apr. 1, 2022

(51) Int. Cl. G06F 21/60

(52) U.S. Cl. CPC G06F 21/602

(57) ABSTRACT

System and techniques for fault tolerant telemetry of distributed devices are described herein. A node includes a hardware component that receives telemetry from an entity resident on the node. The hardware component signs the telemetry with a cryptographic key to create signed telemetry and stores the signed telemetry in memory of the hardware component. Then, upon request from a remote entity, the hardware component provides the signed telemetry.

### TECHNICAL FIELD

Embodiments described herein generally relate to computer network monitoring hardware and more specifically to fault tolerant telemetry of distributed devices.

### BACKGROUND

A computer network comprises interconnected computing devices, often referred to as nodes, that are connected by links. The links ultimately are supported by some physical medium, such as radio waves, light, sound, or magnetic fields in wireless links and wires, such as copper or fiber optics, in wired links. A node includes a network interface to support a physical aspect of a link and generally includes a protocol stack to support a variety of networking protocols.

Computer networks enable complicated collections of nodes. Monitoring nodes may be difficult in such environments, such as when nodes are located over a large area, are numerous, or are remote from human tenders. Network monitoring or management may be accomplished through a variety of techniques, such as the Simple Network Management Protocol (SNMP). With respect to monitoring, these techniques generally produce data, known as telemetry, to describe a state of the monitored node to a central location. Problems may then be detected or predicted at the central location.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for fault tolerant telemetry of distributed devices, according to an embodiment.

FIG. 2 illustrates an example architecture for fault tolerant telemetry hardware, according to an embodiment.

FIG. 3 illustrates an example of a flow to request telemetry, according to an embodiment.

FIG. 4 illustrates an example of a flow to update telemetry, according to an embodiment.

FIG. 5 illustrates a flow diagram of an example of a method for fault tolerant telemetry of distributed devices, according to an embodiment.

FIG. 6 is a schematic diagram of an example infrastructure processing unit (IPU), according to an embodiment.

FIG. 7 is a block diagram illustrating an example of a machine upon which one or more embodiments may be implemented.

### DETAILED DESCRIPTION

In traditional network monitoring, a tool, such as SNMP, may generally be used by a single organization to obtain telemetry on that organization's machines. In such examples, the issues of trust or security largely revolved around preventing others from gaining access to the nodes or the process by which telemetry is gathered. However, some modern computer network architectures are challenging this trust model. For example, hardware necessary to perform some network edge functions, such as implementing a cellular protocol at a base station, have included additional elements to host applications or services for third parties. Generally, the additional elements have been dedicated devices (e.g., appliances) that are lent to the third party. Recent trends are changing again to reduce costs by co-locating several applications or services from various entities (e.g., tenants) on the same hardware. Generally, this hardware has protections to ensure data and processing isolation to maintain the integrity of any tenant application.

In these complex, shared hardware types of deployment models, a challenge emerges. How does a customer access and trust node system data to monitor the systems and understand how the resources are being used; to determine what type of software components are deployed in the appliances or how they behave; or to capture events that maybe related or that may have certain implications for the operating of the network, such as in what location an edge appliance is physically located at a particular point of time. The issue of trust arises because current monitoring techniques are generally software running on a node and are not independent of the hardware or other software in use on the node. That is, existing monitoring systems lack independent techniques to manage device related meta-data in an independent way. Thus, current information (e.g., tracing, system events, software events, etc.) it gathers—either through out of band (OOB) interfaces or captured by software elements and exposed (e.g., shared) via other software elements—may be manipulated or unavailable to a requestor. There is no provision in these techniques to ensure that the data has not been manipulated, nor to gain access to such data were the node to experience a failure.

OOB access is typically associated with device management (e.g., via the board management controller (BMC)). Therefore, these mechanisms are designed to access the node with high-level privileges (e.g., the privileges enable changing the basic configuration of the node including shutting it down) and are safe to be used broadly to access telemetry at any given time. In-band access methods imply that the platform itself must have software instances that perform the gathering and exposure of the telemetry. Thus, there must be trust of the software running on the device, which is also not independent from other software or hardware in operation on the node.

Also, current systems lack the ability for independent entities to generate advanced device related information that may be used at scale, and to decide whether those devices are trustworthy or not. Therefore, external entities (e.g., brokers or other infrastructure service orchestrators) may need to gather certain types of critical information (e.g., validate that the software container registry or that certain libraries have not been modified) in an independent way. Such functionality may be necessary in several circumstances, such as enabling a third party to conduct an audit of hardware or software use on a node.

To address the issues noted above, a dedicated hardware component with direct (e.g., not through a host processor, main memory, etc.) connection to a network interface may be used to securely gather, store, and distribute node telemetry to authorized requests for the telemetry. The stored data may be called a provenance database (PDB) or device PDB (DPD) that is populated, held, and shared by the hardware component. In an example, the hardware component includes its own power source—which along with the direct connection to the network interface—enabling operation (e.g., responding to requests for telemetry) even upon a complete failure of the node in which the hardware component resides.

The DPDs may be widely distributed among network nodes, accessible through cloud or edge-cloud gateways using application programming interfaces (APIs), such as representational state transfer (REST) APIs. DPDs may include capabilities to quickly onboard new communication devices by gathering unforgeable provenance for the new device and verifying device measurements without requiring any other intermediaries or without having to trust local system software. In an example, DPDs include architecture to support fast search as well as for signing each search-result. Local caching may also be used to reduce onboarding time using a bootstrap technique that does not have to trust the system software even as system software is used for sending queries or receiving answers from other DPDs. In an example, system software may even be bypassed when the hardware component implementing the DPD is part of a BMC based OOB network, an infrastructure processing unit (IPU), or network interface. In an example, the DPD enables end-to-end tracing or virtual circuit reservations during testing and onboarding.

With the systems and techniques for fault tolerant telemetry of distributed devices described herein, more advanced edge orchestration or monitoring architectures may be implemented. These architectures may leverage trusted and independent data collection from the devices in order to perform activities such as: selecting where to run edge services; defining monitoring policies to decide whether a particular edge device is trustworthy over time or when certain conditions suggest the device should not run services anymore; determining whether the device has the properties it reports that it has; or accessing independent logging or tracing information, among others. Additional details and examples are provided below.

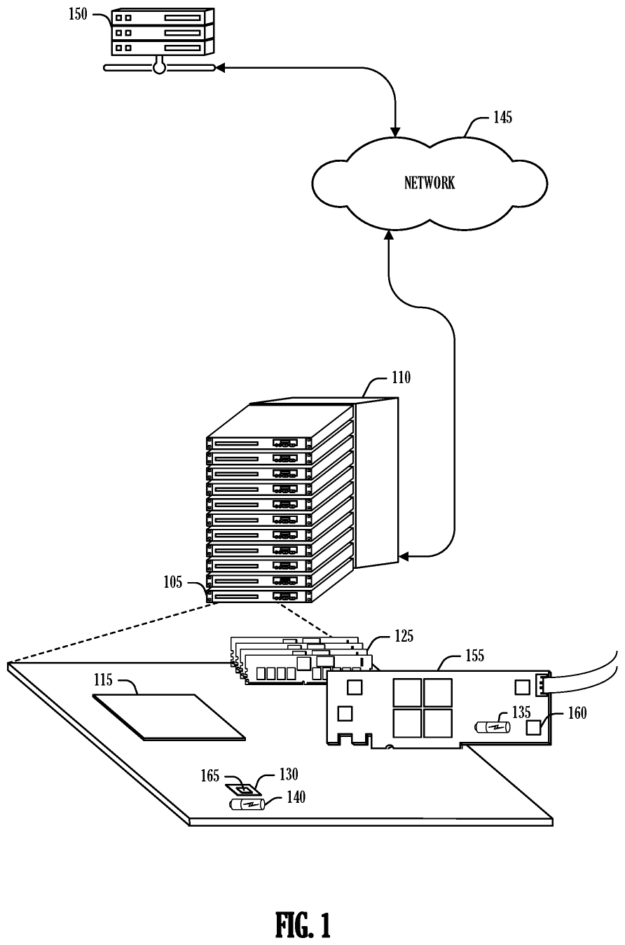

FIG. 1 is a block diagram of an example of an environment including a system for fault tolerant telemetry of distributed devices, according to an embodiment. As illustrated, a node 105 is installed in a chassis 110 and connected via the network 145 to a requestor 150. The node 105 is illustrated with a host processor 115, memory 125, and a network interface 155 to implement applications or services. Other components, such as non-volatile storage, accelerators, sensors, etc. may be included in the node 105 but are omitted here for clarity. The node 105 also includes a BMC 130.

The node 105 also includes a dedicated hardware component to implement a DPD. The hardware component includes processing circuitry and memory within a package or an integrated circuit block. In an example, the hardware component 165 is included in the BMC 130. In an example, the hardware component 160 is included in the network interface 155, which may be an IPU. In an example, the hardware component includes its own network interface. In an example, the hardware component has an independent power supply, such as the battery 140 to support the hardware component 165 in the BMC 130, or the battery 135 to support the hardware component 160 in the network interface 155. With a power supply independent from other components of the node 105, and direct access to a network interface—as is the case when the hardware component has its own network interface or is included in the network interface 155—enables uninterruptable access to the DPD even when the rest of the node 105 is powered down. Further, the direct access to the network 145 ensures that the telemetry provided by the hardware component is not subject to manipulation by other entities of the node 105. In cases where the hardware component does not have its own network interface, or is not part of the network interface 155, the hardware component may be arranged such that no hardware entity is interposes between the hardware component and the network interface 155. Thus, a dedicated communications line, or secured bus, may directly connect the hardware component to the network interface 155 without deviations to the processor 115 or the memory 125.

To implement fault tolerant telemetry, the processing circuitry of the hardware component is configured—e.g., hardwired, by instructions in the memory of the hardware component, or a combination of both—to obtain telemetry from an entity resident on the node 105. Here, the entity may be hardware—such as the processor 115 or memory 125—or software—such as an operating system, application, etc. To obtain the telemetry, the entity may provide the telemetry to the hardware component unprompted, or the hardware component may directly measure hardware or software to obtain the telemetry.

The following examples address various procedures when telemetry is provided to the hardware component. For example, the entity providing the telemetry—such as software executing on the processor 115; a hardware monitor of the memory 125; or a sensor (e.g., satellite positioning device or thermometer)—may collect raw telemetry and then sign (e.g., cryptographically sign) the raw telemetry to create the telemetry. Again, having the telemetry signed by the entity that captured the raw data (e.g., raw telemetry) ensures the provenance (e.g., from whom it came) and integrity (e.g., it is not manipulated) of the telemetry into the hardware component.

In an example, the entity resident on the node 105 writes the telemetry to an internal interface of the hardware component. Here, the internal interface is an interface that connects the hardware component to other hardware of the node 105. In an example, the internal interface is a register of the hardware component. Thus, the entity writes the telemetry to a register bank, or the like, and may set a signal register to indicate the delivery of the telemetry. Other interfaces, such as serial interfaces, parallel interfaces (e.g., Advanced eXtensible Interface (AXI)), or the like may also be used.

In an example, the telemetry is received from the chassis 110 rather than an entity resident on the node 105. Again, the telemetry may be a signed version of raw telemetry captured by the chassis, such as with a sensor of the chassis, and delivered to the hardware component via the network interface 155 or another chassis-to-node interface. Chassis data may be useful when, for example, the node 105 lacks certain capabilities, such as satellite positioning, and the chassis has these capabilities. In such cases, the chassis telemetry is used similarly to telemetry captured by the node 105 were the node 105 capable.

The processing circuitry of the hardware component is configured to sign the telemetry with a cryptographic key of the hardware component to create signed telemetry. Here, the processing circuitry may include cryptographic circuitry to reduce latency in signing. By signing the telemetry, the provenance and integrity of the telemetry data may be ensured with respect to the hardware component. These elements provide a trust chain for the requestor 150 to ensure that the telemetry has not be modified by other tenants of the node 105.

The processing circuitry of the hardware node component is configured to store the signed telemetry within the memory of the hardware component. This memory is not addressable, or otherwise accessible, by other entities of the node 105. Thus, the independence of the DPD is maintained. The arrangement is similar to a trusted computing base (TCB) or similarly protected memory.

To retrieve the telemetry, the requestor 150 makes a request through the network 145. The hardware component receives the request via the network interface 155. The request may include authentication information, a cryptographic key, or other secure identifier of the requestor 150. Once the request is received, the processing circuitry of the hardware component is configured to verify access to the requested telemetry based on the information in the request. Similar to an access control list, this verification ensures that only authorized nodes may gain access to the telemetry upon presentation of appropriate credentials.

Once the request has been verified, the processing circuitry of the hardware component is configured to provide (e.g., transmit via the network interface 155) the signed telemetry to the requestor 150.

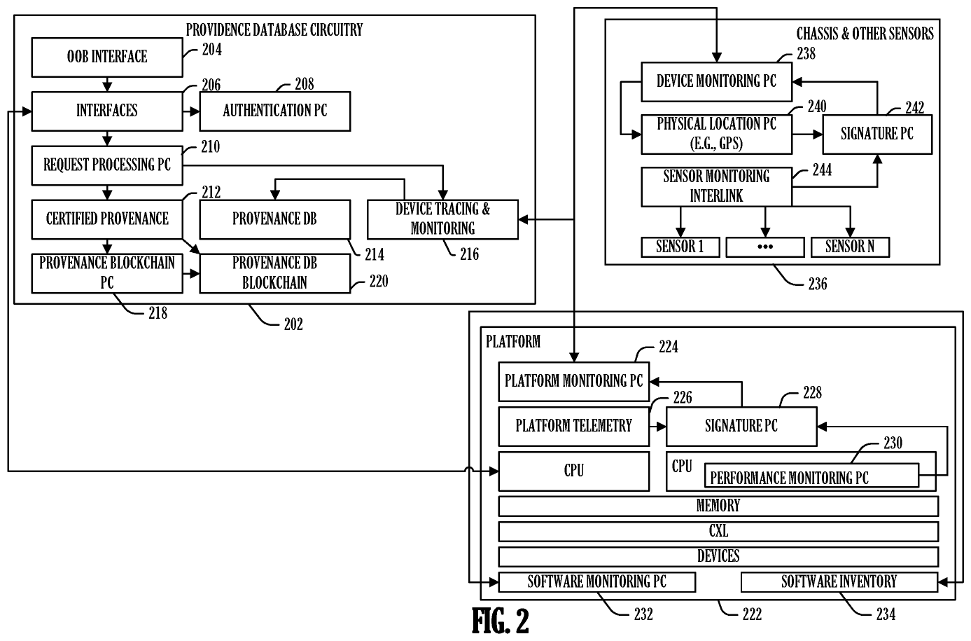

FIG. 2 illustrates an example architecture for fault tolerant telemetry hardware, according to an embodiment. The illustrated provenance database circuitry 202 is an example of the hardware component (e.g., either hardware component 160 or hardware component 165) illustrated in FIG. 1. The provenance database circuitry 202 is illustrated with connectivity to the platform 222 (e.g., the node 105 from FIG. 1) and the chassis & other sensors 236 (e.g., the chassis 110 from FIG. 1). As noted above, the provenance database circuitry 202 is placed outside the compute boundaries of the platform 222, where the main operating system (OS) host or applications are run. This may be accomplished by locating the provenance database circuitry 202 within a BMC, IPU, or discrete accelerator in a node.

As illustrated, the provenance database circuitry 202 includes a set of interfaces—such as OOB interface 204, the in-band network interface 206, or the device tracing and monitoring interface 216—that provide access to the various APIs. In an example, a first API may be used to query or otherwise access to the PDB 214, for example, via the request processing circuitry 210. The first API may support performing a query on the PDB 214, signature, password, or certification to authenticate the entity performing the query and validate the permissions that the entity has to access to the various data sets stored in the PDB 214, for example, using the authentication processing circuitry 208. In an example, the API is available externally by entities remote from the node either via the OOB interface 204 or via a bypass that may come from the in-band network interface 206 shared with other components of the node.

In an example, a second API enables the platform 222 or the chassis 236 to potentially send callbacks to the provenance database circuitry 202 in order to notify the availability of data from certain sensors or metrics for consumption. In an example, the second API is configured to provide an event associated to the data set. This may be a platform 222 related event—such as a temperature increase, new container stored in the registry that cannot be attested, etc.—or chassis event, such as a location change for the node. In an example, the second API is configured to provide a payload associated to the event that will stored in the PDB 214. In an example, the second API is configured to provide a timestamp associated to the event. In an example, the second API is configured to provide a signature that is associated to the event, payload, and timestamp. This provides data hardening by signing inline data provided to the PDB 214, enabling validation that the data has not been compromised (e.g., modified). In an example, the second API is internal to the node, and cannot be accessed by an entity more remote than the chassis of the node.

A third API is configured to support provenance certification (e.g., via the certified provenance processing circuitry 212) and blockchain-type distributed ledger (illustrated as the provenance database blockchain 220) distribution of the telemetry via the provenance blockchain processing circuitry 218. The third API enables maintenance of a blockchain across different sets of devices, whether trusted or not. This provides a mechanism to validate telemetry events that are recorded by a collective of devices over time. The third API may include proof of work as some blockchain-type implementations require devices to generate a proof of work to be added into the blockchain before data may be added to the blockchain. In an example, the third API enables adding an event, payload, a timestamp, or a signature. In an example, the third API provides a source of the device requesting to add an event into the blockchain. These arrangements are useful for events in which having the ability to perform global (e.g., across a network) validation is beneficial.

The platform 222 includes blocks to extract or monitor certain events or meta-data from a node that may be signed and sent back to the provenance database circuitry 202. These blocks may monitor both software and hardware events that may be configured externally or built-in (e.g., predefined) in the device.

Although the device tracing and monitoring processing circuitry 216 may be configured to monitor elements of the node (e.g., the provenance database circuitry 202 or the platform 222), the amount of data to be retrieved may be small (e.g., senor data embedded in the provenance database circuitry 202). The device tracing and monitoring processing circuitry 216 interacts with the platform monitoring processing circuitry 224, as well as the device monitoring processing circuitry 238 of the chassis 236, to gather and collect relevant events. These events are then sent to the provenance database circuitry 202. This arrangement ensures that the telemetry capture and storage is independent to the host running on the device itself.

The platform 222 includes software monitoring processing circuitry 232 configured to monitor different software assets that are running on the platform 222 (e.g., central processing unit (CPU)). The software monitoring processing circuitry 232 operates independently from the host OS running in the platform 222 and is not available by any other element running on the node. The software monitoring processing circuitry 232 is configured to access memory in order to identify software events. For example, the software monitoring processing circuitry 232 may monitor a software inventory 234 that is stored in a second level of memory and identify and validate hashes that correspond to each container image hosted there. Similarly, the software monitoring processing circuitry 232 may be configured to monitor events stored in memory (e.g., OS errors). Generally, the software monitoring processing circuitry 232 is configured, a priory, to identify or search for relevant events to propagate to the PDB 214. This configuration may include being implement using an accelerator or small compute element (e.g., an atom core) that runs specialized programs to do so. Those programs may be updated using standard OOB mechanisms.

The platform 222 may include platform monitoring processing circuitry 224, such as the platform telemetry processing circuitry 226 or the performance monitoring processing circuitry 230. The platform monitoring processing circuitry 224 is configured to collect platform telemetry—such as memory utilization, power consumption, temperature, etc.) or CPU platform telemetry. In an example, the events that are generated are signed inline by the signature processing circuitry 228. Thus, the events that are sent to the provenance database circuitry 202 will have a signature that may be used to validate when the data was generated and by what. In an example, the signature may be bypassed in cases where the number of events or bandwidth to the provenance database circuitry 202 is beyond a predetermined threshold.

The chassis 236 or the node may include blocks that monitor data relative to where or how the node is hosted. Examples may include thermal telemetry, telemetry about movement (e.g., shaking), or position (e.g., via satellite navigation), among other things. Like the platform 222 elements described above, the chassis 236 includes self-monitoring via the device monitoring processing circuitry 238 and monitoring of sensors via the sensor monitoring interlink processing circuitry 244. The chassis 236 may also include location monitoring via the physical location processing circuitry 240. The telemetry produced by these components is signed by the signature processing circuitry 242 inline to the provenance database circuitry 202.

In an example, the physical location processing circuitry 240 is provided whether or not other sensors are included to note events when the platform 222 changes locations as well as include the location as part of any other senor data. In an example, the chassis 236 communicates with the provenance database circuitry 202 via a publication-subscription model. Such as model optimizes monitoring data flows by reducing the number of messages between the provenance database circuitry 202 and the chassis 236. Similarly, sensors may generate events using different types of busses.

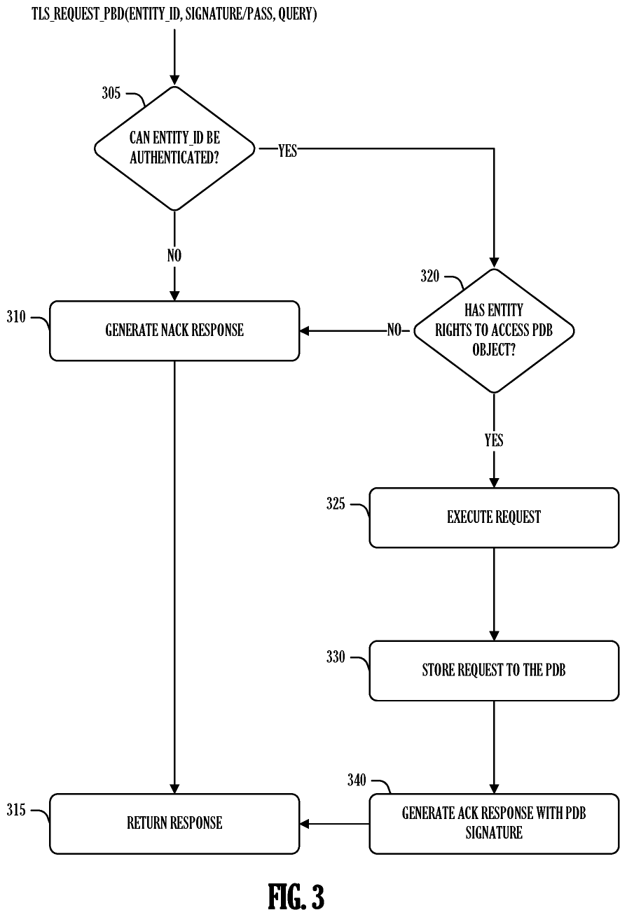

FIG. 3 illustrates an example of a flow to request telemetry, according to an embodiment. As illustrated, interface requests are first authenticated by authentication processing circuitry (e.g., authentication processing circuitry 208 from FIG. 2) (decision 305). If the request is not authenticated, then a negative acknowledgement (NACK) is generated (operation 310) and returned to the requestor (operation 315).

If the authentication passes (decision 305), however, then request processing circuitry (e.g., request processing circuitry 210) checks that the entity has enough rights to access to the data (decision 320). Again, if no, then the NACK is generated (operation 310) and sent (operation 315). In an example, the data is encrypted in the PDB with a key provided by the requestor. Thus, even physical attacks on the PDB will not result in sharing the data with an unauthorized party.

If the request has the proper rights (decision 320), then the request is executed (operation 325), stored to the PDB (operation 330), and a result acknowledgement (ACK) is generated (operation 340) and sent to the requestor (operation 315). Here, external queries are stored in the PDB (operation 330) as another form of monitoring. In an example, what has access to what type of data (e.g., that is mapped into the events) may be provided and configured as part of the device itself (e.g., in firmware) or configured with another API.

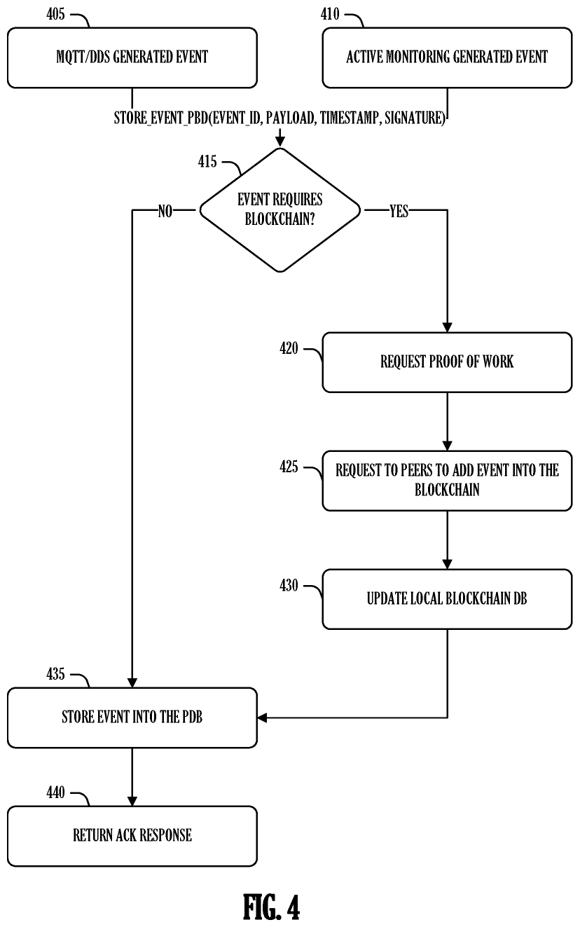

FIG. 4 illustrates an example of a flow to update telemetry, according to an embodiment. The illustrated flow corresponds to event generation that will be stored into the PDB. In an example, a publication-subscription model may be used. In this example, an interface may be used by a corresponding part of the system to provide a notification that an event has been generated. In an example, the PDB may be configured to access a corresponding Message Queueing Telemetry Transport (MQTT) server—or the like such as a Data Distribution Service (DDS) server—to fetch the generated event and continue with the flow (operation 405).

In an example, the event generation may originate from active monitoring (operation 410), such as the device tracing and monitoring processing circuitry 216 illustrated in FIG. 2. In this example, the active monitoring component may constantly monitor different parts of the device (e.g., platform hardware or software, the chassis, etc.) and selecting what events or data to store into the PDB.

In some of the cases, the data stored to the PDB will also be stored in a blockchain and, for example, mapped into a set of devices that are trusted. For example, a decision (e.g., based on type, class, or originator of an event) is evaluated to determine whether it is stored in the blockchain (decision 415). If not, the data is simply stored in the PDB (operation 435), and an ACK is returned (operation 440). However, if the criteria for blockchain inclusion are met (decision 415), proof of work may be generated (operation 420) to request updating of the blockchain by peers (operation 425). The data may be added to a local copy of the blockchain (operation 430). In any case, the data will also be written to the PDB (operation 435), and an ACK sent (operation 440).

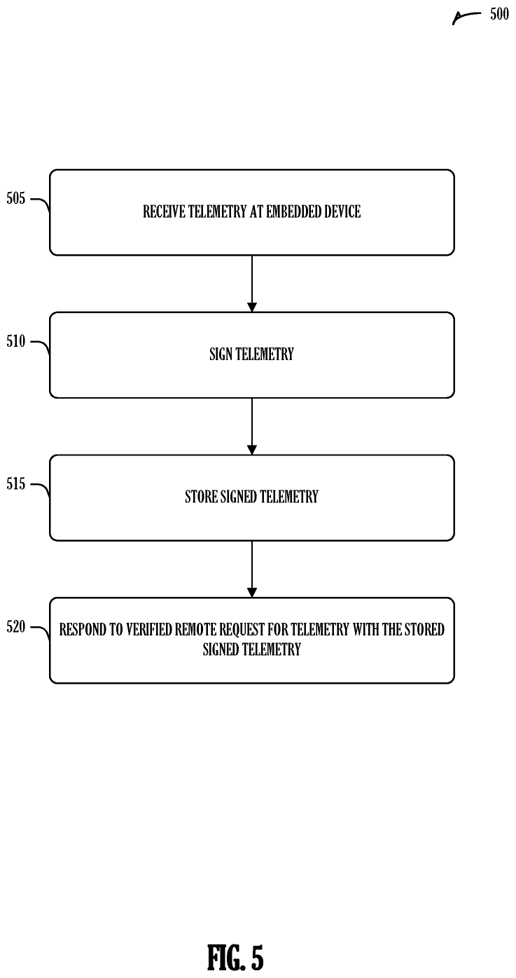

FIG. 5 illustrates a flow diagram of an example of a method 500 for fault tolerant telemetry of distributed devices, according to an embodiment. The operations of the method 500 are performed by computer hardware, such as that described above or below (e.g., processing circuitry).

At operation 505, a hardware component of a node receives telemetry from an entity resident on the node. In an example, the hardware component is part of a board management control unit (BMC) of the node. In an example, the hardware component includes a network interface. In an example, the hardware component is included in an infrastructure processing unit (IPU) of the node. In an example, the hardware component includes a power source independent from node to provide telemetry when power to the node fails.

At operation 510, the telemetry is signed with a cryptographic key of the hardware component to create signed telemetry. In an example, the method 500 includes collecting, by the entity resident on the node, raw telemetry, and signing, by the entity resident on the node, the raw telemetry to create the telemetry. In an example, the entity resident on the node writes the telemetry to an internal interface of the hardware component. In an example, the internal interface is a register of the hardware component. In an example, the entity resident on the node is software running on the node. In an example, the entity resident on the node is a hardware monitor. In an example, the entity resident on the node is a sensor of the node. In an example, the method 500 includes receiving second telemetry from a chassis of the node. The second telemetry is then signed with the cryptographic key of the hardware component to create signed second telemetry. Once created, the signed second telemetry may be stored in the memory of the hardware component.

At operation 515, the signed telemetry is stored in memory of the hardware component.

At operation 520, the signed telemetry is provided upon request from a remote entity. In an example, providing the signed telemetry upon request from a remote entity includes verifying access to the telemetry for a requestor that originated the request prior to transmitting the signed telemetry. In an example, the hardware component, when in operation, is communicatively coupled to a network interface of the node to provide the signed telemetry upon which the request from the remote entity was received. In an example, where the hardware component includes a network interface, providing the signed telemetry includes receiving a request on the network interface of the hardware component, and transmitting the signed telemetry via the network interface of the hardware component.

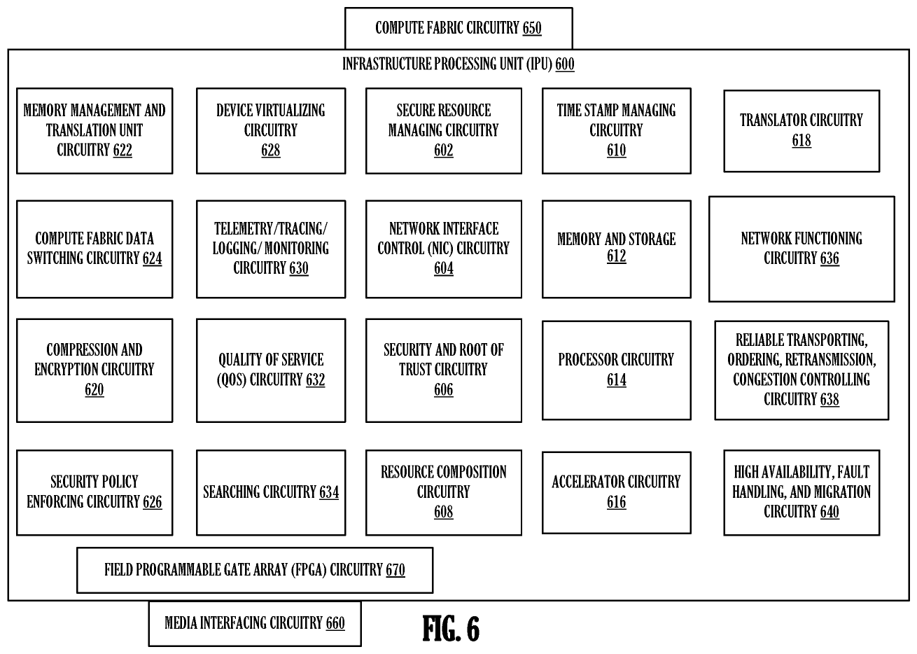

FIG. 6 depicts an example of an infrastructure processing unit (IPU). Different examples of IPUs disclosed herein enable improved performance, management, security and coordination functions between entities (e.g., cloud service providers), and enable infrastructure offload or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein may perform an application including any number of microservices, where each microservice runs in its own process and communicates using protocols (e.g., an HTTP resource API, message service or gRPC). Microservices may be independently deployed using centralized management of these services. A management system may be written in different programming languages and use different data storage technologies.

Furthermore, one or more IPUs may execute platform management, networking stack processing operations, security (crypto) operations, storage software, identity and key management, telemetry, logging, monitoring and service mesh (e.g., control how different microservices communicate with one another). The IPU may access an xPU to offload performance of various tasks. For instance, an IPU exposes XPU, storage, memory, and CPU resources and capabilities as a service that may be accessed by other microservices for function composition. This may improve performance and reduce data movement and latency. An IPU may perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. 6, the IPU 600 includes or otherwise accesses secure resource managing circuitry 602, network interface controller (NIC) circuitry 604, security and root of trust circuitry 606, resource composition circuitry 608, time stamp managing circuitry 610, memory and storage 612, processing circuitry 614, accelerator circuitry 616, or translator circuitry 618. Any number or combination of other structure(s) may be used such as but not limited to compression and encryption circuitry 620, memory management and translation unit circuitry 622, compute fabric data switching circuitry 624, security policy enforcing circuitry 626, device virtualizing circuitry 628, telemetry, tracing, logging and monitoring circuitry 630, quality of service circuitry 632, searching circuitry 634, network functioning circuitry (e.g., routing, firewall, load balancing, network address translating (NAT), etc.) 636, reliable transporting, ordering, retransmission, congestion controlling circuitry 638, and high availability, fault handling and migration circuitry 640 shown in FIG. 6. Different examples may use one or more structures (components) of the example IPU 600 together or separately. For example, compression and encryption circuitry 620 may be used as a separate service or chained as part of a data flow with vSwitch and packet encryption.

In some examples, IPU 600 includes a field programmable gate array (FPGA) 670 structured to receive commands from an CPU, XPU, or application via an API and perform commands/tasks on behalf of the CPU, including workload management and offload or accelerator operations. The illustrated example of FIG. 6 may include any number of FPGAs configured or otherwise structured to perform any operations of any IPU described herein.

Example compute fabric circuitry 650 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry 660 provides connectivity to a remote smartNIC or another IPU or service via a network medium or fabric. This may be provided over any type of network media (e.g., wired or wireless) and using any protocol (e.g., Ethernet, InfiniBand, Fiber channel, ATM, to name a few).

In some examples, instead of the server/CPU being the primary component managing IPU 600, IPU 600 is a root of a system (e.g., rack of servers or data center) and manages compute resources (e.g., CPU, xPU, storage, memory, other IPUs, and so forth) in the IPU 600 and outside of the IPU 600. Different operations of an IPU are described below.

In some examples, the IPU 600 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 600 is selected to perform a workload, secure resource managing circuitry 602 offloads work to a CPU, xPU, or other device and the IPU 600 accelerates connectivity of distributed runtimes, reduce latency, CPU and increases reliability.

In some examples, secure resource managing circuitry 602 runs a service mesh to decide what resource is to execute workload, and provide for L7 (application layer) and remote procedure call (RPC) traffic to bypass kernel altogether so that a user space application may communicate directly with the example IPU 600 (e.g., IPU 600 and application may share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh may provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU 600 dynamically selects itself to run a given workload (e.g., microservice) within a composable infrastructure including an IPU, xPU, CPU, storage, memory, and other devices in a node.

In some examples, communications transit through media interfacing circuitry 660 of the example IPU 600 through a NIC/smartNIC (for cross node communications) or loopback back to a local service on the same host. Communications through the example media interfacing circuitry 660 of the example IPU 600 to another IPU may then use shared memory support transport between xPUs switched through the local IPUs. Use of IPU-to-IPU communication may reduce latency and jitter through ingress scheduling of messages and work processing based on service level objective (SLO).

For example, for a request to a database application that requires a response, the example IPU 600 prioritizes its processing to minimize the stalling of the requesting application. In some examples, the IPU 600 schedules the prioritized message request issuing the event to execute a SQL query database and the example IPU constructs microservices that issue SQL queries and the queries are sent to the appropriate devices or services.

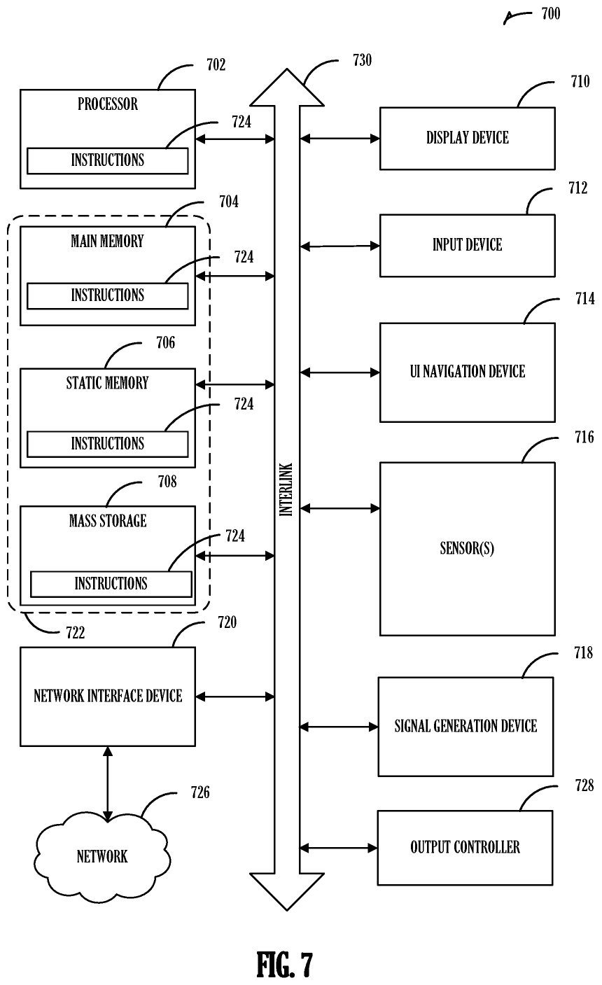

FIG. 7 illustrates a block diagram of an example machine 700 upon which any one or more of the techniques (e.g., methodologies) discussed herein may perform. Examples, as described herein, may include, or may operate by, logic or a number of components, or mechanisms in the machine 700. Circuitry (e.g., processing circuitry) is a collection of circuits implemented in tangible entities of the machine 700 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 700 follow.

In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 700 may include a hardware processor 702 (e.g., a central processing unit (CPU), a graphics processing unit (GPU), a hardware processor core, or any combination thereof), a main memory 704, a static memory (e.g., memory or storage for firmware, microcode, a basic-input-output (BIOS), unified extensible firmware interface (UEFI), etc.) 706, and mass storage 708 (e.g., hard drives, tape drives, flash storage, or other block devices) some or all of which may communicate with each other via an interlink (e.g., bus) 730. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 708, a signal generation device 718 (e.g., a speaker), a network interface device 720, and one or more sensors 716, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 702, the main memory 704, the static memory 706, or the mass storage 708 may be, or include, a machine readable medium 722 on which is stored one or more sets of data structures or instructions 724 (e.g., software) embodying or utilized by any one or more of the techniques or functions described herein. The instructions 724 may also reside, completely or at least partially, within any of registers of the processor 702, the main memory 704, the static memory 706, or the mass storage 708 during execution thereof by the machine 700. In an example, one or any combination of the hardware processor 702, the main memory 704, the static memory 706, or the mass storage 708 may constitute the machine readable media 722. While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 722 may be representative of the instructions 724, such as instructions 724 themselves or a format from which the instructions 724 may be derived. This format from which the instructions 724 may be derived may include source code, encoded instructions (e.g., in compressed or encrypted form), packaged instructions (e.g., split into multiple packages), or the like. The information representative of the instructions 724 in the machine readable medium 722 may be processed by processing circuitry into the instructions to implement any of the operations discussed herein. For example, deriving the instructions 724 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 724.

In an example, the derivation of the instructions 724 may include assembly, compilation, or interpretation of the information (e.g., by the processing circuitry) to create the instructions 724 from some intermediate or preprocessed format provided by the machine readable medium 722. The information, when provided in multiple parts, may be combined, unpacked, and modified to create the instructions 724. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 724 may be further transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software. A transmission medium is a machine readable medium.

### Additional Notes & Examples

Example 1 is a device for fault tolerant telemetry of distributed devices, the device comprising: a connection to a network interface; memory; and processing circuitry configured to: receive telemetry from an entity resident on a node, the device being included in the node; sign the telemetry with a cryptographic key of the device to create signed telemetry; store the signed telemetry in the memory; and provide the signed telemetry upon request from a remote entity.

In Example 2, the subject matter of Example 1 includes, wherein the device includes the network interface, and wherein, to provide the signed telemetry, the processing circuitry is configured to: receive the request via the network interface; and transmit the signed telemetry via the network interface.

In Example 3, the subject matter of Example 2 includes, wherein the device is included in an infrastructure processing unit (IPU) of the node.

In Example 4, the subject matter of Examples 1-3 includes, wherein the device, when in operation, is coupled to a network interface, without intervention by a processor of the node, to provide the signed telemetry upon which the request from the remote entity was received.

In Example 5, the subject matter of Example 4 includes, wherein the device is part of a board management control unit (BMC) of the node.

In Example 6, the subject matter of Examples 1-5 includes, wherein the entity resident on the node collects raw telemetry, and wherein the entity resident on the node signs the raw telemetry to create the telemetry.

In Example 7, the subject matter of Example 6 includes, an internal interface, wherein the entity resident on the node writes the telemetry to an internal interface of the device.

In Example 8, the subject matter of Example 7 includes, wherein the internal interface is a register.

In Example 9, the subject matter of Examples 7-8 includes, wherein the entity resident on the node is software running on the node.

In Example 10, the subject matter of Examples 7-9 includes, wherein the entity resident on the node is a hardware monitor.

In Example 11, the subject matter of Examples 7-10 includes, wherein the entity resident on the node is a sensor of the node.

In Example 12, the subject matter of Examples 1-11 includes, wherein the processing circuitry is configured to: receive second telemetry from a chassis of the node; sign the second telemetry with the cryptographic key of the device to create signed second telemetry; and store the signed second telemetry in the memory of the device.

In Example 13, the subject matter of Examples 1-12 includes, wherein, to provide the signed telemetry upon request from a remote entity, the processing circuitry is configured to verify access to the telemetry for a requestor that originated the request prior to transmitting the signed telemetry.

In Example 14, the subject matter of Examples 1-13 includes, a power source independent from the node to provide telemetry when power to the node fails.

Example 15 is a method for fault tolerant telemetry of distributed devices, the method comprising: receiving, at a hardware component of a node, telemetry from an entity resident on the node; signing the telemetry with a cryptographic key of the hardware component to create signed telemetry; storing the signed telemetry in memory of the hardware component; and providing the signed telemetry upon request from a remote entity.

In Example 16, the subject matter of Example 15 includes, wherein the hardware component includes a network interface, and wherein providing the signed telemetry includes: receiving a request on the network interface; and transmitting the signed telemetry via the network interface.

In Example 17, the subject matter of Example 16 includes, wherein the hardware component is included in an infrastructure processing unit (IPU) of the node.

In Example 18, the subject matter of Examples 15-17 includes, wherein the hardware component, when in operation, is communicatively coupled to a network interface to provide the signed telemetry upon which the request from the remote entity was received.

In Example 19, the subject matter of Example 18 includes, wherein the hardware component is part of a board management control unit (BMC) of the node.

In Example 20, the subject matter of Examples 15-19 includes, wherein the entity resident on the node collects raw telemetry, and wherein the entity resident on the node signs the raw telemetry to create the telemetry.

In Example 21, the subject matter of Example 20 includes, wherein the hardware component includes an internal interface, and wherein the entity resident on the node writes the telemetry to an internal interface of the hardware component.

In Example 22, the subject matter of Example 21 includes, wherein the internal interface is a register of the hardware component.

In Example 23, the subject matter of Examples 21-22 includes, wherein the entity resident on the node is software running on the node.

In Example 24, the subject matter of Examples 21-23 includes, wherein the entity resident on the node is a hardware monitor.

In Example 25, the subject matter of Examples 21-24 includes, wherein the entity resident on the node is a sensor of the node.

In Example 26, the subject matter of Examples 15-25 includes, receiving second telemetry from a chassis of the node; signing the second telemetry with the cryptographic key of the hardware component to create signed second telemetry; and storing the signed second telemetry in the memory of the hardware component.

In Example 27, the subject matter of Examples 15-26 includes, wherein providing the signed telemetry upon request from a remote entity includes verifying access to the telemetry for a requestor that originated the request prior to transmitting the signed telemetry.

In Example 28, the subject matter of Examples 15-27 includes, wherein the hardware component includes a power source independent from the node to provide telemetry when power to the node fails.

Example 29 is a machine readable medium including instructions for fault tolerant telemetry of distributed devices, the instructions, when executed by processing circuitry, cause the processing circuitry to perform operations comprising: receiving, at a hardware component of a node, telemetry from an entity resident on the node; signing the telemetry with a cryptographic key of the hardware component to create signed telemetry; storing the signed telemetry in memory of the hardware component; and providing the signed telemetry upon request from a remote entity.

In Example 30, the subject matter of Example 29 includes, wherein the hardware component includes a network interface, and wherein providing the signed telemetry includes: receiving a request on the network interface; and transmitting the signed telemetry via the network interface.

In Example 31, the subject matter of Example 30 includes, wherein the hardware component is included in an infrastructure processing unit (IPU) of the node.

In Example 32, the subject matter of Examples 29-31 includes, wherein the hardware component, when in operation, is communicatively coupled to a network interface to provide the signed telemetry upon which the request from the remote entity was received.

In Example 33, the subject matter of Example 32 includes, wherein the hardware component is part of a board management control unit (BMC) of the node.

In Example 34, the subject matter of Examples 29-33 includes, wherein the entity resident on the node collects raw telemetry, and wherein the entity resident on the node signs the raw telemetry to create the telemetry.

In Example 35, the subject matter of Example 34 includes, wherein the hardware component includes an internal interface, and wherein the entity resident on the node writes the telemetry to an internal interface of the hardware component.

In Example 36, the subject matter of Example 35 includes, wherein the internal interface is a register of the hardware component.

In Example 37, the subject matter of Examples 35-36 includes, wherein the entity resident on the node is software running on the node.

In Example 38, the subject matter of Examples 35-37 includes, wherein the entity resident on the node is a hardware monitor.

In Example 39, the subject matter of Examples 35-38 includes, wherein the entity resident on the node is a sensor of the node.

In Example 40, the subject matter of Examples 29-39 includes, wherein the operations comprise: receiving second telemetry from a chassis of the node; signing the second telemetry with the cryptographic key of the hardware component to create signed second telemetry; and storing the signed second telemetry in the memory of the hardware component.

In Example 41, the subject matter of Examples 29-40 includes, wherein providing the signed telemetry upon request from a remote entity includes verifying access to the telemetry for a requestor that originated the request prior to transmitting the signed telemetry.

In Example 42, the subject matter of Examples 29-41 includes, wherein the hardware component includes a power source independent from the node to provide telemetry when power to the node fails.

Example 43 is a system for fault tolerant telemetry of distributed devices, the system comprising: means for receiving, at a hardware component of a node, telemetry from an entity resident on the node; means for signing the telemetry with a cryptographic key of the hardware component to create signed telemetry; means for storing the signed telemetry in memory of the hardware component; and means for providing the signed telemetry upon request from a remote entity.

In Example 44, the subject matter of Example 43 includes, wherein the hardware component includes a network interface, and wherein the means for providing the signed telemetry include: means for receiving a request on the network interface; and means for transmitting the signed telemetry via the network interface.

In Example 45, the subject matter of Example 44 includes, wherein the hardware component is included in an infrastructure processing unit (IPU) of the node.

In Example 46, the subject matter of Examples 43-45 includes, wherein the hardware component, when in operation, is communicatively coupled to a network interface to provide the signed telemetry upon which the request from the remote entity was received.

In Example 47, the subject matter of Example 46 includes, wherein the hardware component is part of a board management control unit (BMC) of the node.

In Example 48, the subject matter of Examples 43-47 includes, wherein the entity resident on the node collects raw telemetry, and wherein the entity resident on the node signs the raw telemetry to create the telemetry.

In Example 49, the subject matter of Example 48 includes, wherein the hardware component includes an internal interface, and wherein the entity resident on the node writes the telemetry to an internal interface of the hardware component.

In Example 50, the subject matter of Example 49 includes, wherein the internal interface is a register of the hardware component.

In Example 51, the subject matter of Examples 49-50 includes, wherein the entity resident on the node is software running on the node.

In Example 52, the subject matter of Examples 49-51 includes, wherein the entity resident on the node is a hardware monitor.

In Example 53, the subject matter of Examples 49-52 includes, wherein the entity resident on the node is a sensor of the node.

In Example 54, the subject matter of Examples 43-53 includes, means for receiving second telemetry from a chassis of the node; means for signing the second telemetry with the cryptographic key of the hardware component to create signed second telemetry; and means for storing the signed second telemetry in the memory of the hardware component.

In Example 55, the subject matter of Examples 43-54 includes, wherein the means for providing the signed telemetry upon request from a remote entity include means for verifying access to the telemetry for a requestor that originated the request prior to transmitting the signed telemetry.

In Example 56, the subject matter of Examples 43-55 includes, wherein the hardware component includes a power source independent from the node to provide telemetry when power to the node fails.

Example 57 is at least one machine-readable medium including instructions that, when executed by processing circuitry, cause the processing circuitry to perform operations to implement of any of Examples 1-56.

Example 58 is an apparatus comprising means to implement of any of Examples 1-56.

Example 59 is a system to implement of any of Examples 1-56.

Example 60 is a method to implement of any of Examples 1-56.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device for fault tolerant telemetry of distributed devices, the device comprising:
a connection to a network interface;
memory; and
processing circuitry configured to:
receive telemetry from an entity resident on a node, the device being included in the node;
sign the telemetry with a cryptographic key of the device to create signed telemetry;
store the signed telemetry in the memory; and
provide the signed telemetry upon request from a remote entity.

2. The device of claim 1, wherein the device includes the network interface, and wherein, to provide the signed telemetry, the processing circuitry is configured to:
receive the request via the network interface; and
transmit the signed telemetry via the network interface.

3. The device of claim 2, wherein the device is included in an infrastructure processing unit (IPU) of the node.

4. The device of claim 1, wherein the device, when in operation, is coupled to a network interface, without intervention by a processor of the node, to provide the signed telemetry upon which the request from the remote entity was received.

5. The device of claim 4, wherein the device is part of a board management control unit (BMC) of the node.

6. The device of claim 1, wherein the entity resident on the node collects raw telemetry, and wherein the entity resident on the node signs the raw telemetry to create the telemetry.

7. The device of claim 6, comprising an internal interface, wherein the entity resident on the node writes the telemetry to an internal interface of the device.

8. The device of claim 1, comprising a power source independent from the node to provide telemetry when power to the node fails.

9. A method for fault tolerant telemetry of distributed devices, the method comprising:
receiving, at a hardware component of a node, telemetry from an entity resident on the node;
signing the telemetry with a cryptographic key of the hardware component to create signed telemetry;
storing the signed telemetry in memory of the hardware component; and
providing the signed telemetry upon request from a remote entity.

10. The method of claim 9, wherein the hardware component includes a network interface, and wherein providing the signed telemetry includes:
receiving a request on the network interface; and
transmitting the signed telemetry via the network interface.

11. The method of claim 9, wherein the hardware component, when in operation, is communicatively coupled to a network interface to provide the signed telemetry upon which the request from the remote entity was received.

12. The method of claim 9, wherein the entity resident on the node collects raw telemetry, and wherein the entity resident on the node signs the raw telemetry to create the telemetry.

13. The method of claim 12, wherein the hardware component includes an internal interface, and wherein the entity resident on the node writes the telemetry to an internal interface of the hardware component.

14. A non-transitory machine readable medium including instructions for fault tolerant telemetry of distributed devices, the instructions, when executed by processing circuitry, cause the processing circuitry to perform operations comprising:
receiving, at a hardware component of a node, telemetry from an entity resident on the node;
signing the telemetry with a cryptographic key of the hardware component to create signed telemetry;
storing the signed telemetry in memory of the hardware component; and
providing the signed telemetry upon request from a remote entity.

15. The non-transitory machine readable medium of claim 14, wherein the hardware component includes a network interface, and wherein providing the signed telemetry includes:
receiving a request on the network interface; and
transmitting the signed telemetry via the network interface.

16. The non-transitory machine readable medium of claim 15, wherein the hardware component is included in an infrastructure processing unit (IPU) of the node.

17. The non-transitory machine readable medium of claim 14, wherein the hardware component, when in operation, is communicatively coupled to a network interface to provide the signed telemetry upon which the request from the remote entity was received.

18. The non-transitory machine readable medium of claim 17, wherein the hardware component is part of a board management control unit (BMC) of the node.

19. The non-transitory machine readable medium of claim 14, wherein the entity resident on the node collects raw telemetry, and wherein the entity resident on the node signs the raw telemetry to create the telemetry.

20. The non-transitory machine readable medium of claim 19, wherein the hardware component includes an internal interface, and wherein the entity resident on the node writes the telemetry to an internal interface of the hardware component.

21. The non-transitory machine readable medium of claim 14, wherein the hardware component includes a power source independent from the node to provide telemetry when power to the node fails.

22. A system for fault tolerant telemetry of distributed devices, the system comprising:
means for receiving, at a hardware component of a node, telemetry from an entity resident on the node;
means for signing the telemetry with a cryptographic key of the hardware component to create signed telemetry;
means for storing the signed telemetry in memory of the hardware component; and
means for providing the signed telemetry upon request from a remote entity.

23. The system of claim 22, wherein the hardware component includes a network interface, and wherein the means for providing the signed telemetry include:
means for receiving a request on the network interface; and
means for transmitting the signed telemetry via the network interface.

24. The system of claim 22, wherein the hardware component includes a power source independent from the node to provide telemetry when power to the node fails.
